(19) United States
(12) Patent Application Publication
(10) Pub. No.: US 2015/0027617 A1
(43) Pub. Date: Jan. 29, 2015

(54) SINGLE FACER AND INSPECTION METHOD THEREFOR

(71) Applicant: KABUSHIKI KAISHA ISOWA, Nagoya-shi (JP)

(72) Inventors: Hisashi HAYASHI, Kiyosu-shi (JP); Takahiro YAMADA, Kasugai-shi (JP); Naoki MORI, Komaki-shi (JP)

(21) Appl. No.: 14/337,785

(22) Filed: Jul. 22, 2014

(30) Foreign Application Priority Data
Jul. 26, 2013 (JP) 2013-155120

(51) Int. Cl. B32B 29/08

(52) U.S. Cl. CPC B32B 29/08
USPC 156/64; 156/378

(57) ABSTRACT

Disclosed is a single facer for producing a single-faced corrugated paperboard. The single facer comprises a first corrugating roll pivotally rotatably supported at axially opposite ends thereof; a second corrugating roll pivotally rotatably supported at axially opposite ends thereof through respective bearing units, and disposed in opposed relation to the first corrugating roll; a gluing roll disposed in opposed relation to the first corrugating roll; a parallelism inspection apparatus for inspecting parallelism between the first corrugating roll and the second corrugating roll. The parallelism inspection apparatus comprises: an actuating section for moving the bearing units of the second corrugating roll; and a detecting section provided in the actuating section to detect values of a physical quantity transmitted, respectively, from the bearing units, wherein the parallelism inspection apparatus, based on the detected values of the physical quantity, detects the parallelism between the first corrugating roll and the second corrugating roll.

### RELATED APPLICATIONS

This application claims priority under 35 U.S.C. §119 to Japanese Patent Application No. 2013-155120 filed on Jul. 26, 2013, the entire content of which is hereby incorporated by reference.

### BACKGROUND OF THE INVENTION

1. Technical Field

The present invention relates to a single facer and an inspection method therefor, and particularly to a single facer equipped with a parallelism inspection apparatus for inspecting parallelism between corrugating rolls, etc., and an inspection method for such a single facer.

2. Background Art

A single facer is a machine for producing a single-faced corrugated paperboard sheet which comprises a corrugated medium formed from a planar corrugating medium to have corrugated flutes, and a planar linerboard glued onto tip regions of the flutes (flute tip regions) of the corrugated medium.

For example, as illustrated in FIG. 14, in a single facer 200, an upper corrugating roll 201 and a lower corrugating roll 202 each having a corrugated fluted portion formed in an outer peripheral surface thereof are rotatably arranged in an up-down direction while being meshed with each other through the respective fluted portions. A corrugating medium NR fed from a right side is passed through between the upper corrugating roll 201 and the lower corrugating roll 202, and thereby fabricated into a corrugated medium having corrugated flutes each continuously formed in a direction (axial direction) orthogonal to a feed direction thereof.

In the single facer 200, a gluing roll 203 rotatably disposed leftward and obliquely downward of and adjacent to the upper corrugating roll 201, and a pressure roll 204 is rotatably disposed leftward and obliquely upward of and adjacent to the upper corrugating roll 201. The gluing roll 203 operates to apply a bonding glue solution to flute tip regions of the corrugated medium, and the pressure roll 204 operates to glue a linerboard UR fed from a left side, onto the flute tip regions applied with the glue solution, whereby a single-faced corrugated paperboard sheet DB is produced. The produced single-faced corrugated paperboard sheet DB is continuously transferred upwardly via a turn-up roll 205.

In the above single facer 200, in order to avoid defective gluing, etc., in a single-faced corrugated paperboard sheet DB as a product thereof, it is necessary to adjust parallelism between every adjacent two of various rolls, such as between the upper corrugating roll 201 and the lower corrugating roll 202, between the upper corrugating roll 201 and the pressure roll 204, or between the upper corrugating roll 201 and the gluing roll 203, in such a manner as to fall within a given range. For example, if the parallelism between the upper and lower corrugating rolls does not fall within the given range, a meshed state between the fluted portions of the two corrugating rolls becomes uneven, and therefore a height of each flute tip region of a corrugated medium formed by means of nipping between the fluted portions is likely to become uneven. The uneven height of each flute tip region of the corrugated medium is likely to cause poor bonding and the occurrence of wrinkles, meandering, etc., during subsequent gluing of the linerboard UR, resulting in defective gluing.

Therefore, as one example of a technique of inspecting parallelism between the rolls in the single facer 200, there has been known a pressure-sensitive sheet-based inspection method in which, as illustrated in FIG. 14, a pressure-sensitive sheet (carbon sheet) CB is passed through between the corrugating rolls in the arrowed direction S to form indented lines, and it is visually inspected whether or not the indented lines are formed at equal intervals. FIG. 15 illustrates a situation where indented lines CJ formed in the pressure-sensitive sheet CB are created by flute tip regions and flute bottom (valley) regions and spaced apart from each other by an equal distance A. In this situation, it can be determined that the upper corrugating roll 201 and the lower corrugating roll 202 are arranged in parallel relation in the axial direction. FIG. 16 illustrates a situation where indented lines CJ formed in the pressure-sensitive sheet CB are created by flute ramp surfaces and spaced apart from each other by a relatively wide distance B and a relatively narrow distance C. In this situation, it can be determined that the upper corrugating roll 201 and the lower corrugating roll 202 are arranged with a deviation in parallelism therebetween in the axial direction (this parallelism will hereinafter be referred to simply and occasionally as “inter-roll parallelism”). In the situation where the upper and lower corrugating rolls are arranged with a deviation in the inter-roll parallelism, the inter-roll parallelism has been adjusted by rotationally moving an eccentric pin supporting a bearing unit of the lower corrugating roll 202, to adjust a distance between axes of the two corrugating rolls (inter-roll axis distance).

Further, JP 05-096668A (Patent Document 1) discloses an automatic setting apparatus for a single facer, wherein the single facer is equipped with: a contact pressure adjusting device for variably changing an inter-roll engagement state between an upper corrugating roll and a lower corrugating roll and/or between the lower corrugating roll and a pressure roll or any other roll; and a clearance adjusting device for variably changing an inter-roll engagement state between the lower corrugating roll and a gluing roll, between the gluing roll and a doctor roll and/or between the lower corrugating roll and the pressure roll, and capable of variably setting a contact state between each set of the mutually engaged rolls. The automatic setting apparatus is configured to allow an operator to selectively operate a keyboard of a condition setting operator control panel based on specifications of raw materials for use in production, to thereby cause each of the adjusting devices to operate so as to adjust the contact state between each set of the mutually engaged rolls in accordance with a preliminarily-input given setup value.

### SUMMARY OF THE INVENTION

However, the conventional pressure-sensitive sheet-based inspection method described above and the single facer automatic setting apparatus disclosed in the Patent Document 1 have the following problems.

In the pressure-sensitive sheet-based inspection method, parallelism is inspected by; after stopping operation of the single facer, inserting a pressure-sensitive sheet, for example, between the corrugating rolls; then after restarting the operation of the single facer, passing the pressure-sensitive sheet through between the corrugating rolls; and visually checking indented lines formed in the pressure-sensitive sheet.

However, the indented lines formed in the pressure-sensitive sheet are not always clear. Thus, accurate inspection based on visual evaluation requires proficient skills and repetitive inspections. Moreover, the pressure-sensitive sheet-based inspection is a bothersome work because a person has to enter the machine to perform the inspection. Further, during the pressure-sensitive sheet-based inspection, the single facer cannot be used for the production of single-faced corrugated paperboard sheets, so that there is a problem of deterioration in capacity utilization.

Therefore, it has been expected to provide a single facer capable of performing an inter-roll parallelism inspection accurately and easily within a short period of time, and an inspection method for such a single facer.

On that point, in the single facer automatic setting apparatus disclosed in the Patent Document 1, when an operator selectively operates the keyboard of the condition setting operator control panel based on specifications of raw materials for use in production, each of the adjusting devices operates so as to automatically adjust the contact state between each set of the engaged rolls in accordance with a preliminarily-input given setup value, so that it is not necessary to stop the operation of the single facer for each adjustment.

However, the contact state between each set of the engaged rolls changes due to vibration during the operation of the single facer, roll replacement, etc., and further changes over time due to wear of the rolls. Thus, even when the adjustment is performed in accordance with a preliminarily-input given setup value, as in the apparatus disclosed in the Patent Document 1, it is difficult to allow the inter-roll parallelism to always fall within a given range.

Meanwhile, corrugating rolls and other rolls of a single facer are generally subjected to heating using stream or the like. Thus, under an influence of a difference in thermal expansion coefficient between the corrugating rolls and other rolls, and a frame of the single facer, the inter-roll parallelism is likely to change during operation of the single facer.

Therefore, the pressure-sensitive sheet-based inspection method in which the inspection is performed in the state in which the operation of the single facer is stopped (during non-operation of the single facer) has a problem of difficulty in accurately figuring out parallelism between the corrugating rolls, etc., during actual operation of the single facer.

The automatic setting apparatus disclosed in the Patent Document 1 also has a problem of failing to cope with a change in the inter-roll parallelism due to thermal expansions in the corrugating rolls and other rolls, and a frame of the single facer, during the operation of the single facer.

The present invention has been made to solve the above problem, and a first object of the present invention is to provide a single facer capable of performing inspection of parallelism between a first corrugating roll and a second corrugating roll, accurately and easily within a short period of time, and an inspection method for such a single facer.

Further, a second object of the present invention is to provide a single facer capable of accurately inspect the parallelism between the first corrugating roll and the second corrugating roll, even during actual operation of the single facer, and an inspection method for such a single facer.

(1) In order to achieve the above objects, the present invention provides a single facer for producing a single-faced corrugated paperboard in which a linerboard is glued to flute tip regions of a corrugated medium formed with corrugated flutes. The single facer comprises: a first corrugating roll pivotally rotatably supported at axially opposite ends thereof; a second corrugating roll pivotally rotatably supported at axially opposite ends thereof through respective bearing units, and disposed in opposed relation to the first corrugating roll; a gluing roll disposed in opposed relation to the first corrugating roll; a parallelism inspection apparatus for inspecting parallelism between the first corrugating roll and the second corrugating roll, the parallelism inspection apparatus comprising: an actuating section configured to move the bearing units of the second corrugating roll forwardly and backwardly with respect to the first corrugating roll; and a detecting section provided in the actuating section to detect values of a physical quantity transmitted, respectively, from the bearing units, and wherein the parallelism inspection apparatus, based on the detected values of the physical quantity, detects the parallelism between the first corrugating roll and the second corrugating roll.

In the present invention, the detecting section for detecting values of a physical quantity transmitted, respectively, from the bearing units, is provided in the actuating section for moving the second corrugating roll disposed in opposed relation to the first corrugating roll pivotally rotatably supported at axially opposite ends thereof, forwardly and backwardly with respect to the first corrugating roll. Thus, it becomes possible to inspect the parallelism between the first corrugating roll and the second corrugating roll accurately and easily within a short period of time, by comparing the values of the physical quantity detected by the detecting section.

Specifically, when there is a deviation in the parallelism between the first corrugating roll and the second corrugating roll, the deviation is maximized at the axially opposite ends of the second corrugating roll. Further, values of a physical quantity such as shock load or displacement occurring at the axially opposite ends of the second corrugating roll, for example, due to meshing between corrugated fluted portions formed in respective outer peripheral surfaces of the first corrugating roll and the second corrugating roll disposed in opposed relation to the first corrugating roll are effectively transmitted, via the bearing units pivotally supporting the respective axially opposite ends.

Thus, the deviation in the parallelism between the first corrugating roll and the second corrugating roll can be maximally and effectively detected as a difference between values of the physical quantity detected by the detecting section.

Therefore, it becomes possible to inspect whether the parallelism between the first corrugating roll and the second corrugating roll is in a normal state or in an abnormal state, accurately and easily within a short period of time, by comparing the values of the physical quantity detected by the detecting section.

Thus, the present invention makes it possible to perform inspection of the parallelism between the first corrugating roll and the second corrugating roll accurately and easily within a short period of time, even by an unskilled person. In addition, an operator can perform the parallelism inspection without entering the single facer, so that it becomes possible to eliminate the need to stop the operation of the single facer, and accurately inspect the inter-roll parallelism during actual operation of the single facer.

(2) Preferably, in the single facer of the present invention, the actuating section and the detecting section of the parallelism inspection apparatus are, respectively, a pressure cylinder and a pressure gauge.

According to this feature, shock loads occurring at axially opposite ends of one of the first and second corrugating rolls, for example, during meshing between the fluted portions of the first and second corrugating rolls, are detected by using a pressure gauge, so that it becomes possible to inspect adequacy of the inter-roll parallelism accurately and easily within a short period of time.

Specifically, the detecting section of the parallelism inspection apparatus is a pressure gauge, so that a shock load occurring, for example, during mashing between the fluted portions, can be output in the form of a load curve which periodically rises and falls.

Further, the pressure gauge is provided in a pressure cylinder, so that the shock load can be detected while being separated as an axial component load of the pressure cylinder.

The pressure cylinder is the actuating section configured to move the bearing units of the second corrugating roll forwardly and backwardly with respect to the first corrugating roll, so that the axial component load of the pressure cylinder intercorrelates with the distance between the axes of the first and second corrugating rolls (inter-roll axis distance).

Thus, the deviation in the parallelism between the first corrugating roll and the second corrugating roll appears as a cycle offset amount (delay time) in two load curves detected by the pressure gauge, with high sensitivity.

Therefore, it becomes possible to inspect the inter-roll parallelism accurately and easily within a short period of time by a level of the cycle offset amount in the load curves.

Further, it becomes possible to, based on a change in the load curves during operation of the single facer, accurately inspect the parallelism between the first corrugating roll and the second corrugating roll during actual operation of the single facer.

In some cases, the cycle offset amount in the load curves appears as a time lag with which respective peak values in the load curves appears. In these cases, the adequacy of the parallelism between the first corrugating roll and the second corrugating roll can be inspected more easily with a shorter period of time, by a level of the time lag with which the respective peak values appear, without accurately calculating the cycle offset amount in the load curves.

On the other hand, in a situation where the parallelism between the first corrugating roll and the second corrugating roll is adequate, the first corrugating roll and the second corrugating roll come into contact with each other with an axially even contact pressure. Thus, in some cases, a shock load occurring, for example, during meshing between the fluted portions of the first and second corrugating rolls, is distributed, so that maximum values in the load curves become lower and equal to each other. In these cases, the adequacy of the parallelism between the first corrugating roll and the second corrugating roll can be inspected more easily with a shorter period of time, by comparing only the maximum values in the load curves.

(3) Preferably, the single facer of the present invention further comprises a cartridge in which the first corrugating roll and the second corrugating roll are arranged in opposed relation to each other, wherein each of the bearing units of the second corrugating roll has one end pivotally supported by the cartridge through a shaft pin, and the other end coupled to the actuating section, and wherein at least one of the shaft pins is an eccentric pin.

According to this feature, the single facer is provided with the cartridge in which the first corrugating roll and the second corrugating roll are arranged in opposed relation to each other, so that the inter-roll parallelism can be inspected and adjusted through the cartridge. The intermediation of the cartridge makes it possible to reduce noise from the second corrugating roll and others.

Further, each of the bearing units has one end (first end) pivotally supported by the cartridge through a shaft pin, and the other end (second end) coupled to the actuating section. Thus, when the fluted portions of the first corrugating roll and the second corrugating roll are meshed with each other, the second end of the bearing unit is swingingly moved about the first end serving as a support point. Therefore, a movement of the bearing unit can be transmitted to the actuating section coupled to the second end, while being amplified by the swinging movement of the second end.

Therefore, according to this feature, the detecting section provided in the actuating section can detect values of a physical quantity based on a temporal delay (lag) in terms of a meshing timing between the fluted portion of the first corrugating roll and the fluted portion of the second corrugating roll, in an amplified manner while reducing noise. This makes it possible to inspect the adequacy of the inter-roll parallelism based on a difference between the detected values of the physical quantity, more accurately and easily with a shorter period of time. Further, at least one of the shaft pins each pivotally supporting a respective one of the first ends of the bearing units is an eccentric pin, so that the inter-roll parallelism can be easily adjusted by rotationally moving the eccentric pin so as to adjust the inter-roll axis distance.

(4) Preferably, the single facer of the present invention further comprises a display device configured to display the values of the physical quantity detected by the detecting section, in associated relation with a temporal axis.

According to this feature, during operation of the single facer, an operator can monitor a temporal change in the physical quantity displayed on the display device to thereby accurately figure out the parallelism between the first corrugating roll and the second corrugating roll during actual operation of the single facer.

Specifically, in a situation where, due to a temperature rise after start of operation of the single facer, the parallelism between the first corrugating roll and the second corrugating roll is changed under an influence of a difference in thermal expansion coefficient between the corrugating rolls and other rolls, and a frame of the single facer, abnormality of the parallelism between the first corrugating roll and the second corrugating roll can be quickly inspected by monitoring a temporal change in the physical quantity displayed on the display device. In addition, adjustment of the parallelism between the first corrugating roll and the second corrugating roll can be performed before the parallelism deviates from a given criterion value.

Thus, this feature makes it possible to accurately inspect the parallelism between the first corrugating roll and the second corrugating roll during actual operation of the single facer to prevent the defective gluing from occurring.

Examples of means to display values of the physical quantity in relation to a temporal axis include: a technique of displaying values of the physical quantity in the form of a temporally continuous curve; a technique of intermittently displaying values of the physical quantity at certain time intervals; and a technique of displaying peak values of the physical quantity in correlated relation with respective occurrence times of the peak values.

(5) Preferably, the single facer of the present invention further comprises an automatic adjusting device configured to, based on the values of the physical quantity detected by the detecting section, automatically adjust a deviation in the parallelism between the first corrugating roll and the second corrugating roll.

According to this feature, the parallelism between the first corrugating roll and the second corrugating roll can be maintained in a normal state while accurately inspecting the inter-roll parallelism during actual operation of the single facer, without stopping the operation of the single facer.

Specifically, even in the situation where the parallelism between the first corrugating roll and the second corrugating roll is changed during operation of the single facer, under an influence of a difference in thermal expansion coefficient between the corrugating rolls and other rolls, and a frame of the single facer, the inter-roll parallelism can be automatically adjusted according to the change in such a manner that it falls within a given criterion value.

Thus, according to this feature, not only during installation of the single facer or corrugating roll replacement but also during actual operation of the single facer, a deviation in the parallelism of the corrugating roll, etc., can be automatically adjusted while accurately inspecting the parallelism. This makes it possible to realize production of high-accuracy single-faced corrugated paperboard sheets while enhancing capacity utilization.

(6) Preferably, in the single facer of the present invention, the gluing roll is pivotally rotatably supported at axially opposite ends thereof through respective bearing units, wherein the single facer further comprises a second parallelism inspection apparatus for inspecting parallelism between the first corrugating roll and the gluing roll, and wherein the second parallelism inspection apparatus comprises: a second actuating section configured to move the bearing units of the gluing roll forwardly and backwardly with respect to the first corrugating roll; and a second detecting section provided in the second actuating section to detect values of a physical quantity transmitted, respectively, from the bearing units of the gluing roll, and wherein the second parallelism inspection apparatus is operable, based on the detected values of the physical quantity, to detect the parallelism between the first corrugating roll and the gluing roll.

Thus, this feature makes it possible to perform inspection of the parallelism between the first corrugating roll and the gluing roll accurately and easily within a short period of time, even by an unskilled person. In addition, an operator can perform the parallelism inspection without entering the single facer, so that it becomes possible to eliminate the need to stop the operation of the single facer, and accurately inspect the inter-roll parallelism during actual operation of the single facer.

(7) More preferably, the above single facer further comprises: a gluing housing to which the gluing roll is mounted and the bearing units of the gluing roll are attached, wherein the second actuating section is coupled to the gluing housing; an eccentric cam provided in each of the bearing units of the gluing roll in eccentric relation to an axis of the gluing roll; and a stopper pin fixedly disposed in contact with an outer peripheral surface of the eccentric cam, wherein at least one of the stopper pins is an eccentric pin.

In the single facer of the present invention, in terms of a timing when the fluted portion of the first corrugating roll and an outer peripheral surface of the gluing roll come into press contact with each other while interposing a corrugated medium therebetween, a temporal delay (lag) occurs at the axially opposite ends of the gluing roll (the first corrugating roll), in proportion to a deviation in the inter-roll parallelism.

According to this feature, the single spacer is provided with the gluing housing to which the gluing roll is mounted and the bearing units of the gluing roll are attached, so that the parallelism between the first corrugating roll and the gluing roll can be inspected and adjusted through the gluing housing. The intermediation of the gluing housing makes it possible to reduce noise from other rolls mounted to a single facer body of the single facer.

Further, the second actuating section is coupled to the gluing unit. Thus, a movement of each of the bearing units of the gluing roll can be transmitted to the second actuating section coupled to the gluing unit.

Further, the eccentric cam is provided in each of the bearing units of the gluing roll in eccentric relation to the axis of the gluing roll, so that a distance between axes of the first corrugating roll and the gluing roll can be easily set depending on a thickness of a corrugated medium, by rotationally moving the eccentric cam. Thus, the eccentric cam makes it possible to reduce an error in values of the physical quantity detected by the second detecting section, due to a difference in thickness of a corrugated medium.

The temporal delay (lag) in terms of the timing when the fluted portion of the first corrugating roll and the outer peripheral surface of the gluing roll come into press contact with each other while interposing a corrugated medium therebetween appears as a temporal delay in terms of a press-contact force transmitted to the second actuating section.

In the second parallelism inspection apparatus, the second detecting section is provided in the second actuating section, so that it becomes possible to accurately detect values of the physical quantity based on the temporal delay (lag) in terms of the timing when the fluted portion of the first corrugating roll and the outer peripheral surface of the gluing roll come into press contact with each other while interposing a corrugated medium therebetween, while reducing noise. This makes it possible to inspect the adequacy of the inter-roll parallelism based on a difference between the detected values of the physical quantity, more accurately and easily with a shorter period of time.

Further, at least one of the stopper pins in contact with the outer peripheral surface of the eccentric cam is an eccentric pin, so that the inter-roll parallelism can be easily adjusted by rotationally moving the eccentric pin so as to adjust the inter-roll axis distance.

(8) The present invention also provides a method of inspecting the above single facer. The method comprises calculating the cycle offset amount in the values of the physical quantity detected by the detecting section, and determining adequacy of the parallelism between the first corrugating roll and the second corrugating roll, depending on whether or not the cycle offset amount falls within a given criterion value.

In the method of the present invention, the adequacy of the parallelism between the first corrugating roll and the second corrugating roll is determined depending on whether or not the cycle offset amount falls within a given criterion value, so that whether the parallelism between the first corrugating roll and the second corrugating roll is in a normal state or in an abnormal state can be determined in a quantitative way, accurately and easily within a short period of time.

Specifically, when a calculation result of the cycle offset amount in the values of the physical quantity detected by the detecting section provided in the actuating section is greater than the given criterion value, it is quickly determined that the parallelism between the first corrugating roll and the second corrugating roll is in the abnormal state, and, on the other hand, when the calculation result is equal to or less than the given criterion value, it is quickly determined that the parallelism between the first corrugating roll and the second corrugating roll is in the normal state.

Thus, the method of the present invention makes it possible to perform inspection of the parallelism between the first corrugating roll and the second corrugating roll easily without a short period of time without requiring proficiency. In addition, although a conventional method such as the pressure-sensitive sheet-based inspection method requires that the operation of the single facer is stopped and an operator enters the single facer, in order to perform the inspection, the method of the present invention can eliminate such requirements. The method of the present invention can also be used in inspection in which the inter-roll parallelism during an actual operation of single facer is continuously monitored.

The present invention can provide a single facer capable of performing inspection of the parallelism between the first corrugating roll and the second corrugating roll, accurately and easily within a short period of time, and an inspection method for such a single facer. The present invention can also provide a single facer capable of accurately inspect the parallelism between the first corrugating roll and the second corrugating roll, even during actual operation of the single facer, and an inspection method for such a single facer.

### BRIEF DESCRIPTION OF THE DRAWINGS

FIG. 1 is a front view of a single facer according to one embodiment of the present invention.

FIG. 2 is a front view of a first corrugating roll and a second corrugating roll of the single facer illustrated in FIG. 1.

FIG. 3 is a back view of the first corrugating roll and the second corrugating roll of the single facer illustrated in FIG. 1.

FIG. 4 is an axial sectional view of the second corrugating roll of the single facer illustrated in FIG. 1.

FIG. 5 is a front view of an eccentric pin adjusting mechanism (second example) in the second corrugating roll of the single facer illustrated in FIG. 1.

FIG. 6 is a sectional view of the eccentric pin adjusting mechanism illustrated in FIG. 5.

FIG. 7 is a back view of a gluing housing of the single facer illustrated in FIG. 1.

FIG. 8 is a fragmentary sectional view of the gluing roll of the single facer illustrated in FIG. 1.

FIG. 9 is a side view of the first corrugating roll and the second corrugating roll of the single facer illustrated in FIG. 1.

FIG. 10 is a sectional view of a stopper pin mounting structure of a gluing housing illustrated in FIG. 9.

FIG. 11 is a front view of an adjusting mechanism for a stopper pin illustrated in FIG. 10.

FIG. 12 is a graph presenting load curves (before parallelism adjustment) based on pressure gauges provided in respective pressure cylinders of the second corrugating roll of the single facer illustrated in FIG. 1.

FIG. 13 is a graph presenting load curves (after the parallelism adjustment) based on the pressure gauges provided in the respective pressure cylinders of the second corrugating roll of the single facer illustrated in FIG. 1.

FIG. 14 is a layout diagram of various rolls in a conventional single facer.

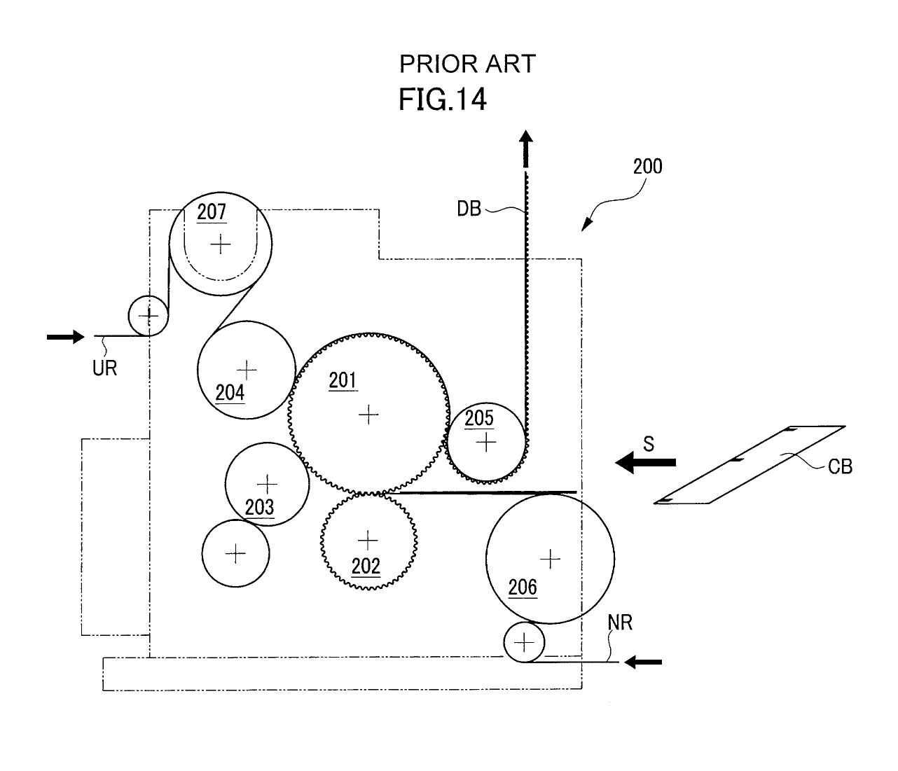

FIG. 15 is an explanatory diagram of a result of pressure-sensitive sheet-based inspection (after parallelism adjustment) for corrugating rolls of the single facer illustrated in FIG. 14.

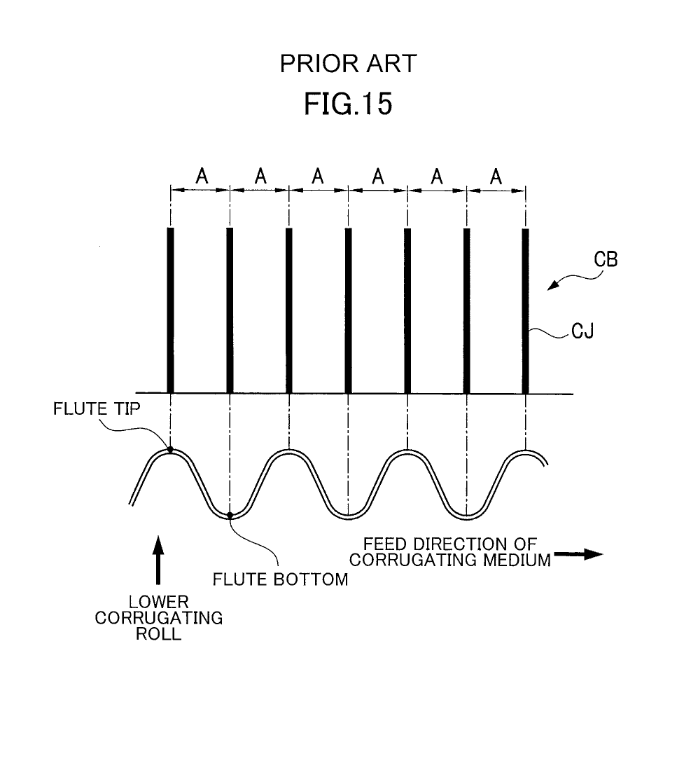

FIG. 16 is an explanatory diagram of a result of pressure-sensitive sheet-based inspection (before parallelism adjustment) for the corrugating rolls of the single facer illustrated in FIG. 14.

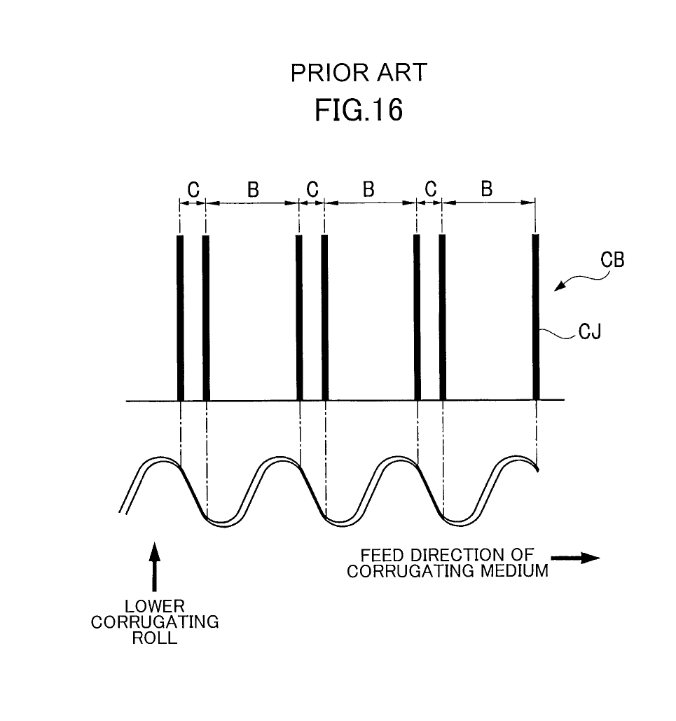

### DETAILED DESCRIPTION OF THE PREFERRED EMBODIMENTS

With reference to the drawings, the present invention will now be described in detail based on a single facer according to one embodiment thereof

First of all, a general configuration of the single facer according to this embodiment will be described. Then, a parallelism inspection apparatus for inspecting inter-roll parallelism and an inspection method therefor will be described based on load curves before and after parallelism adjustment for corrugating rolls as a specific example of rolls.

### <General Configuration of Single Facer>

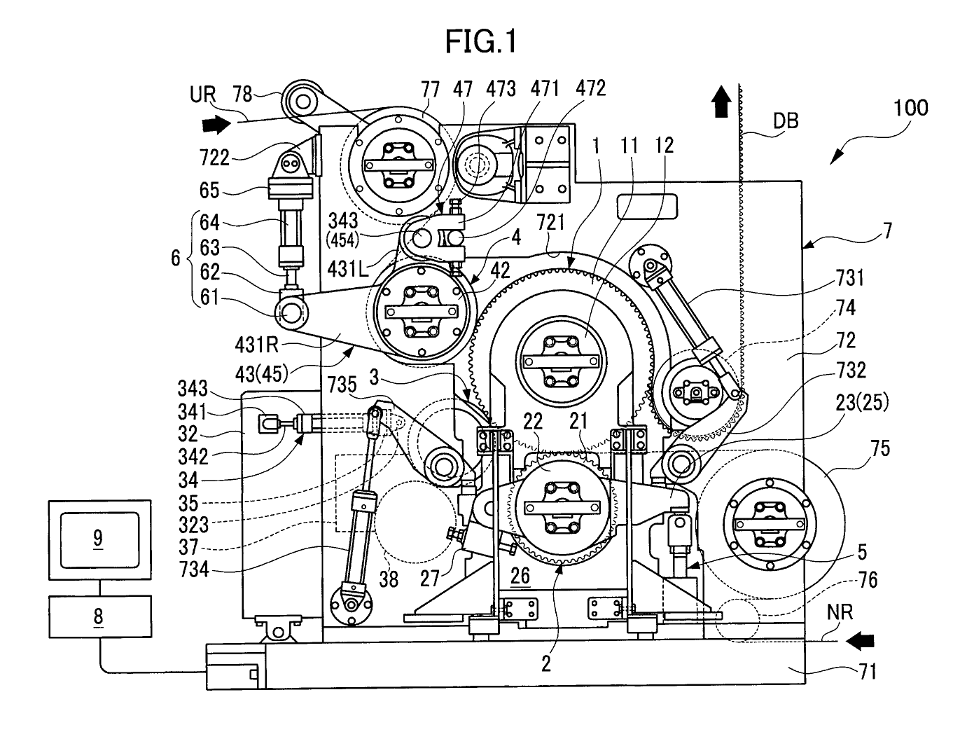

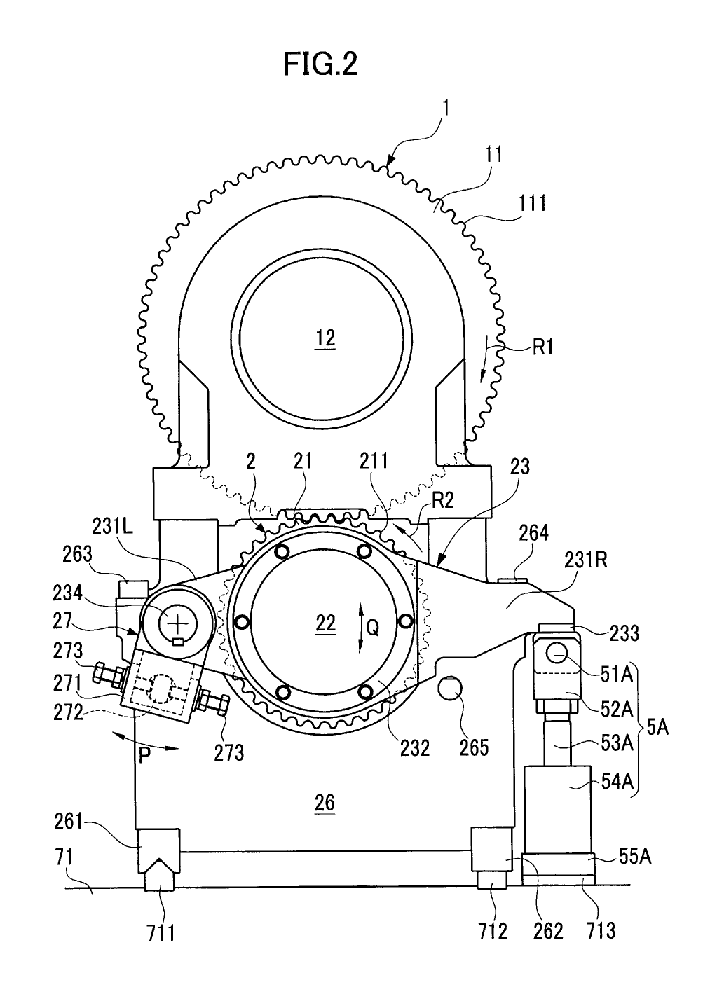

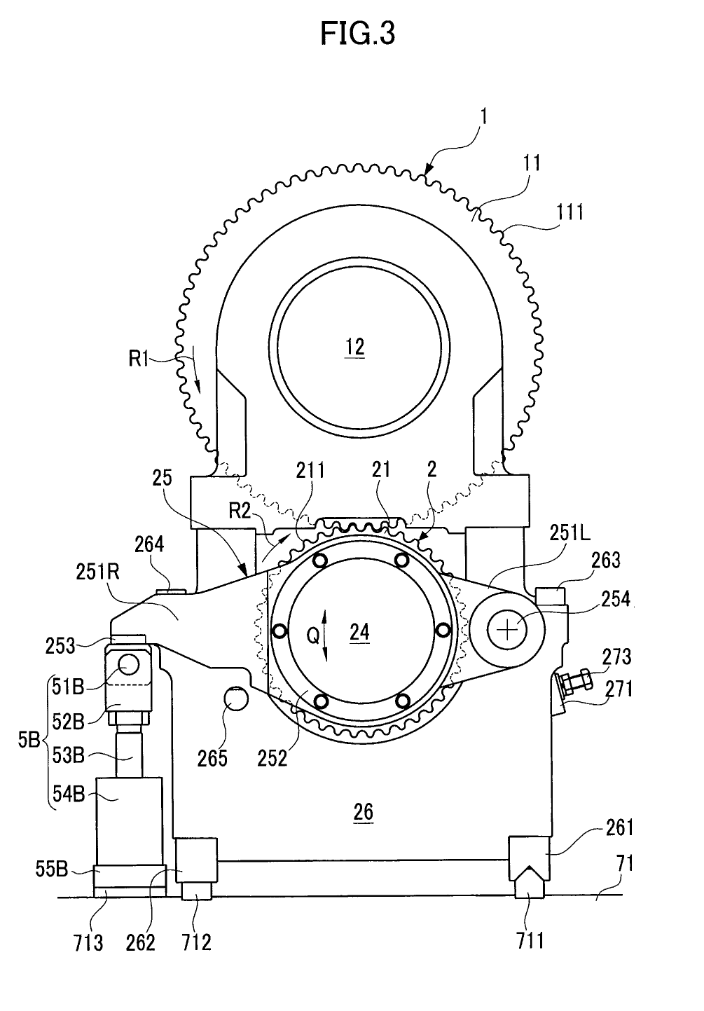

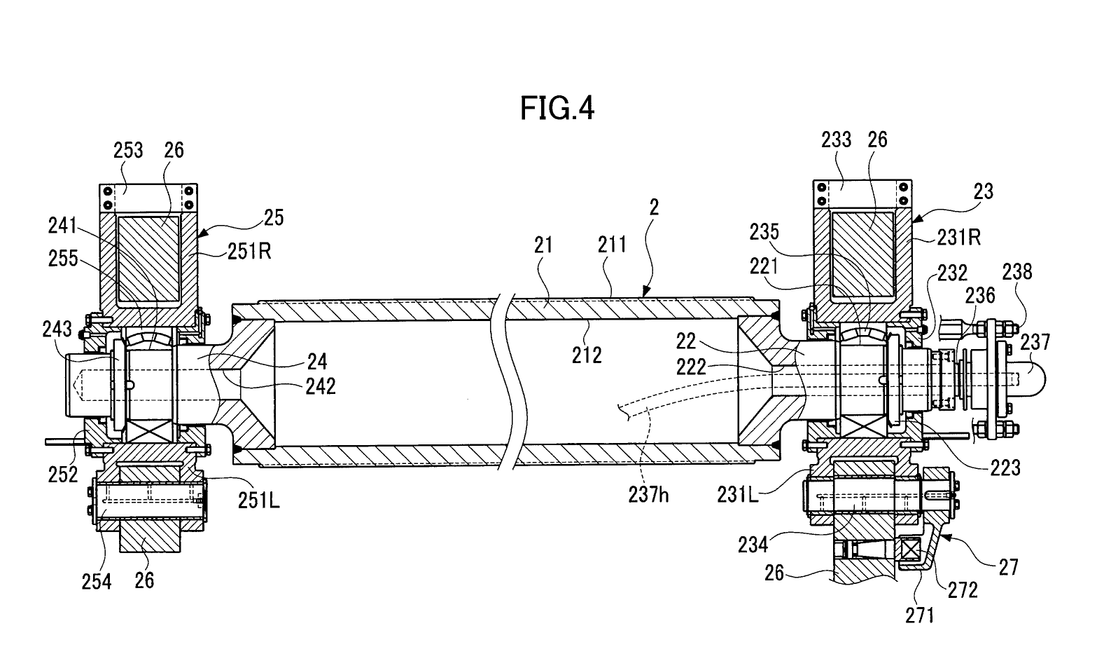

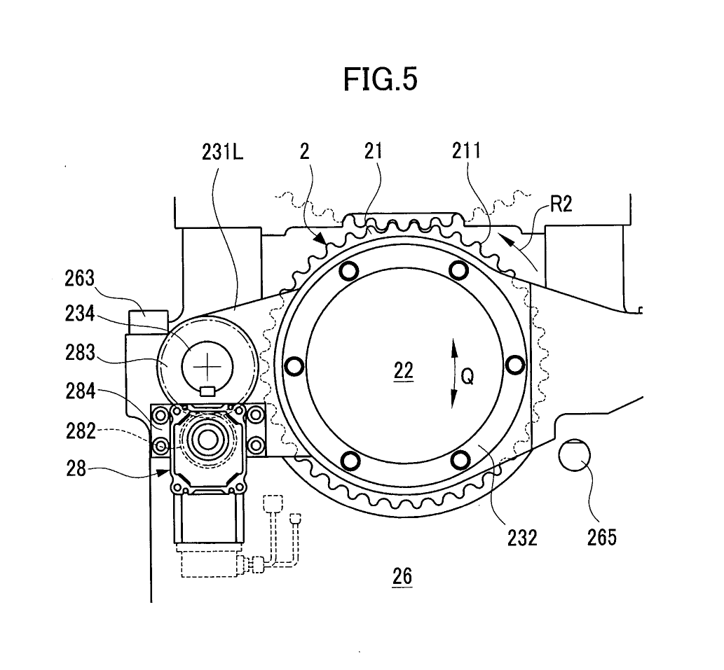

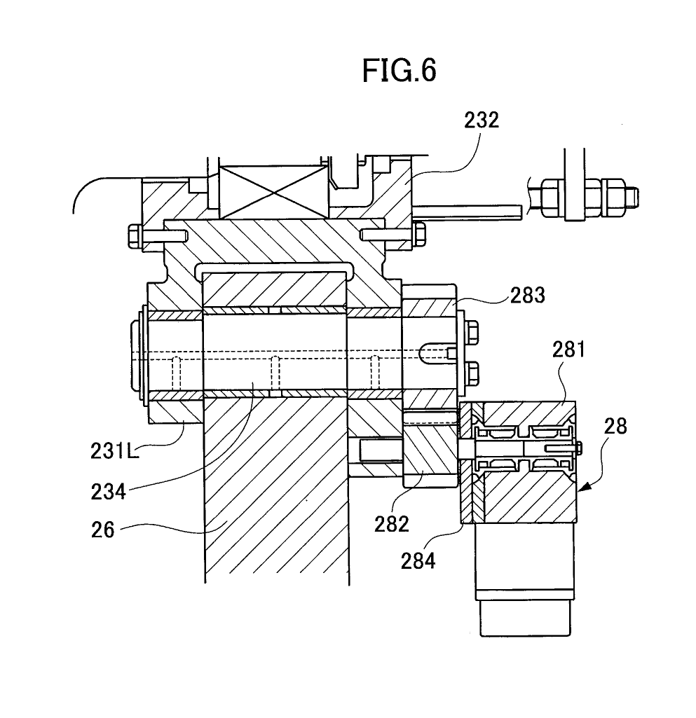

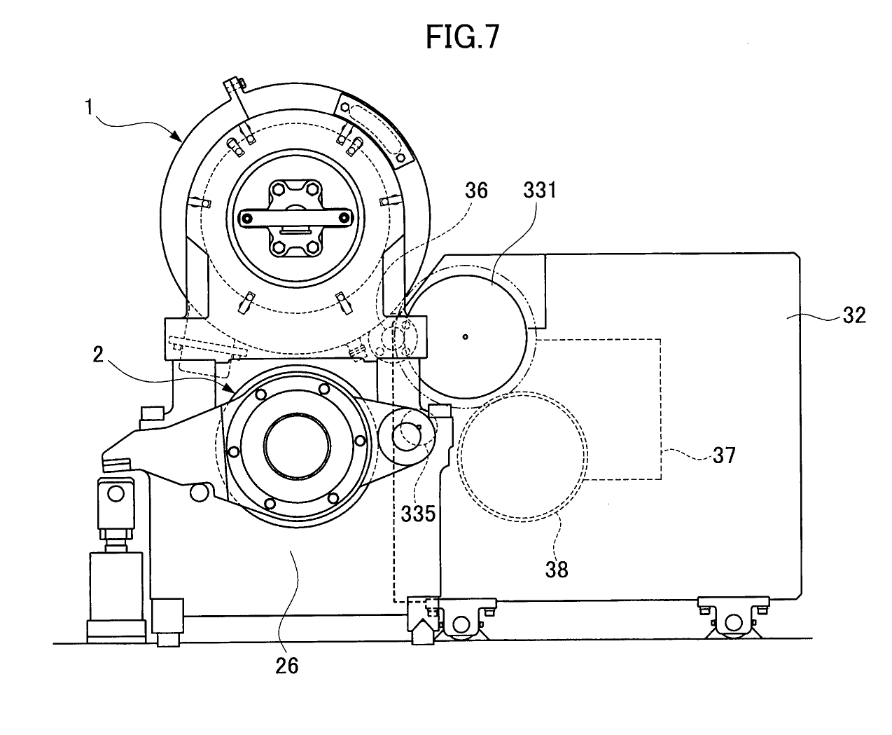

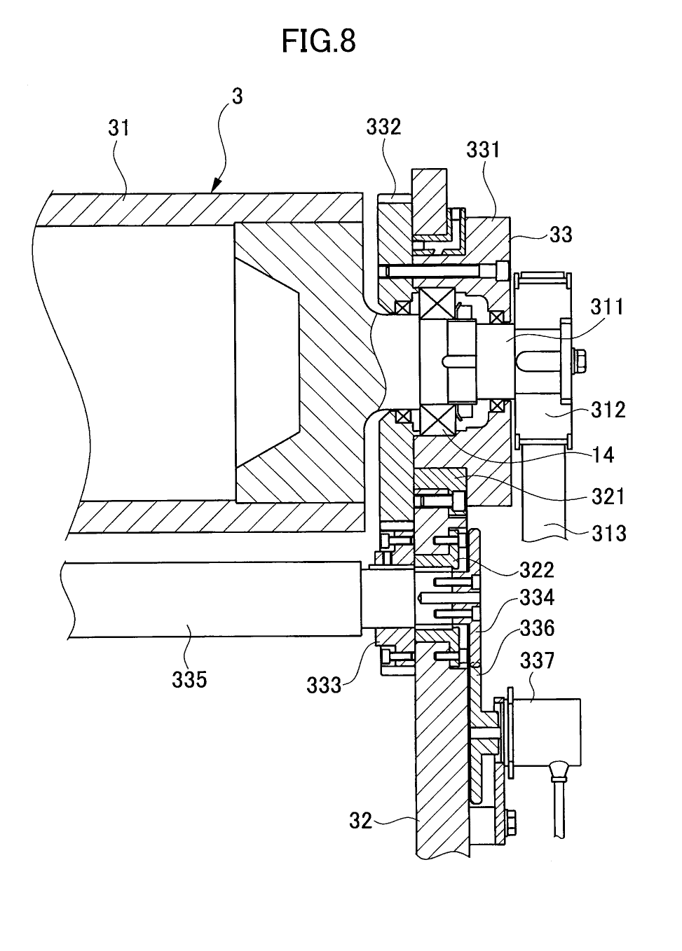

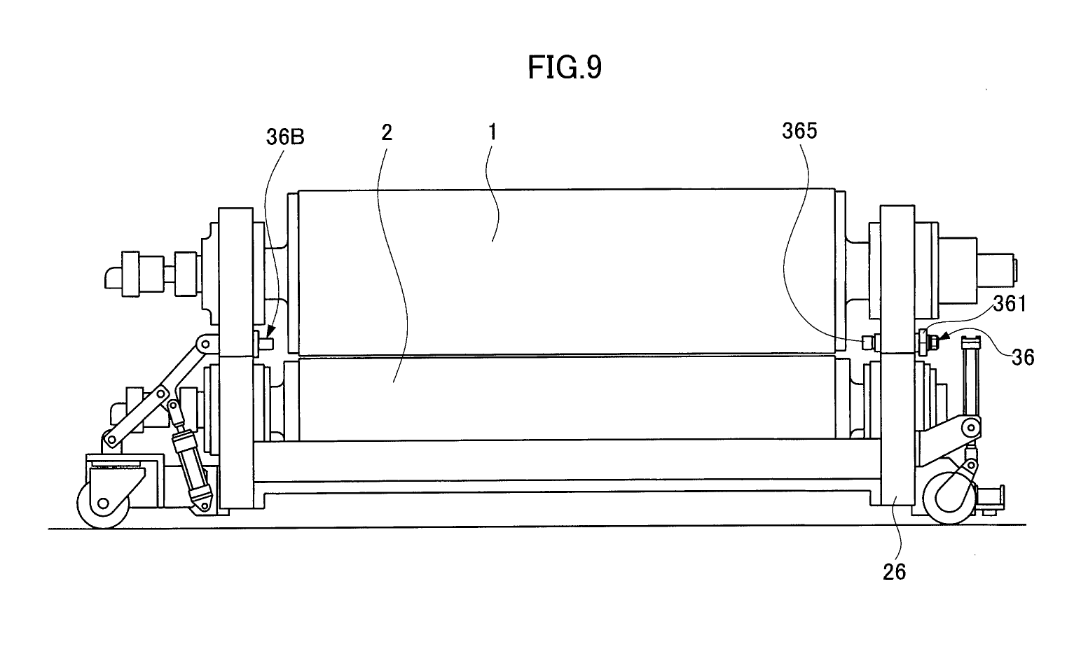

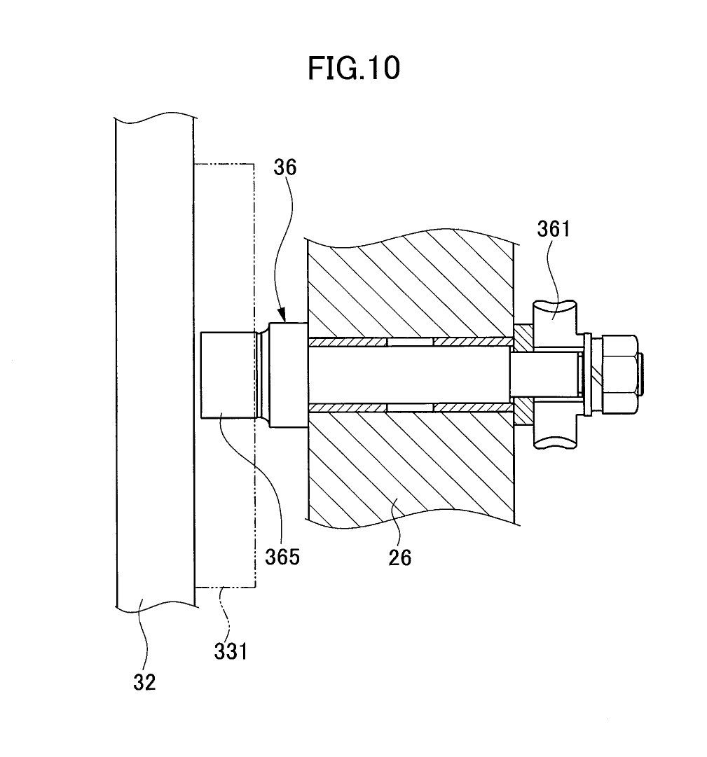

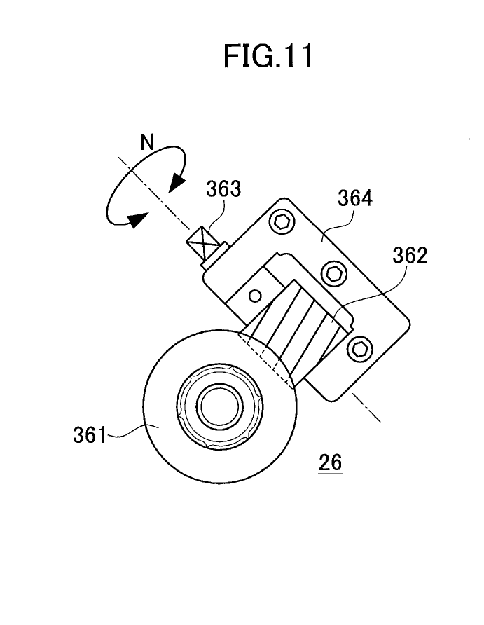

A general configuration of the single facer according to this embodiment will first be described with reference to FIGS. 1 to 11. FIG. 1 is a front view of a front view of the single facer according to this embodiment. FIG. 2 is a front view of a first corrugating roll and a second corrugating roll of the single facer illustrated in FIG. 1. FIG. 3 is a back view of the first corrugating roll and the second corrugating roll of the single facer illustrated in FIG. 1. FIG. 4 is an axial sectional view of the second corrugating roll of the single facer illustrated in FIG. 1. FIG. 5 is a front view of an eccentric pin adjusting mechanism (second example) in the second corrugating roll of the single facer illustrated in FIG. 1. FIG. 6 is a sectional view of the eccentric pin adjusting mechanism illustrated in FIG. 5. FIG. 7 is a back view of a gluing roll of the single facer illustrated in FIG. 1. FIG. 8 is a fragmentary sectional view of the gluing roll of the single facer illustrated in FIG. 1. FIG. 9 is a side view of the first corrugating roll and the second corrugating roll of the single facer illustrated in FIG. 1. FIG. 10 is a sectional view of a stopper pin mounting structure of a gluing housing illustrated in FIG. 9. FIG. 11 is a front view of an adjusting mechanism for a stopper pin illustrated in FIG. 10. FIGS. 1 and 2 are views when viewed from an operating side of the single facer, and FIG. 3 is a view when viewed from a driving side of the single facer.

As illustrated in FIG. 1, the single facer 100 according to this embodiment comprises a first corrugating roll 1, a second corrugating roll 2, a gluing roll 3, a pressure roll 4, a corrugating roll actuating section 5, a gluing roll actuating section 34, a pressure roll actuating section 6, a single facer body 7, an aftermentioned processing device 8, and an aftermentioned display device 9.

### (First Corrugating Roll and Second Corrugating Roll)

As illustrated in FIGS. 2 and 3, the first corrugating roll 1 is a metal roll member which has a roll body 11 composed of a cylindrical body, and two shaft portions 12 each protruding outwardly from a respective one of axially opposite ends of the roll body 11. The roll body 11 has an outer peripheral surface defined by a corrugated fluted portion 111 formed with a plurality of flutes each extending in the axial direction. Each of the shaft portions 12 is rotatably fixed to a cartridge 26 mounted on the single facer body 7 movably with respect to the single facer body 7.

The second corrugating roll 2 is disposed in opposed relation to the first corrugating roll 1 at a position just below the first corrugating roll 1. The second corrugating roll 2 is a metal roll member which has a roll body 21 and two shaft portions 22, 24, as with the first corrugating roll 1. The roll body 21 has an outer peripheral surface defined by a corrugated fluted portion 211 meshed with the fluted portion 111 of the first corrugating roll 1. The shaft portions 22, 24 of the second corrugating roll 2 are rotatably fixed, respectively, to two bearing units 23, 25. Each of the bearing units 23, 25 is swingably locked to the cartridge 26.

The first corrugating roll 1 and the second corrugating roll 2 are attached to the cartridge 26 in such a manner that their rotational axes are arranged in parallel in an up-down direction. Two rail members 261, 262 each extending in the axial direction are fastened to a lower end of the cartridge 26. The rail members 261, 262 are in sliding contact, respectively, with two guide members 711, 712 each extending along a bedplate 71 of the single facer body 7.

The first corrugating roll 1 and the second corrugating roll 2 are configured to be rotated, respectively, in directions indicated by the arrowed lines R1, R2, while maintaining meshing between the fluted portions 111, 211 thereof. The single facer 100 according to this embodiment employs a structure in which a driving-side one of the shaft portions 12 of the first corrugating roll 1 is coupled to a driving device (not illustrated) disposed on the driving side, and the second corrugating roll 2 is rotated in such a manner as to follow rotation of the first corrugating roll 1. The bearing unit 23 and the bearing unit 25 of the second corrugating roll 2 are disposed, respectively, on the operating side and the driving side of the single facer 100.

The operating-side bearing unit 23 and the driving-side bearing unit 25 have, respectively, a set of arm portions 231R, 231L formed, respectively, to protrude rightwardly and leftwardly, and a set of arm portions 251R, 251L formed, respectively, to protrude rightwardly and leftwardly. In the operating-side bearing unit 23, the arm portion 231L on the side of one end (first end) thereof is pivotally supported by the cartridge 26 through a shaft pin (eccentric pin) 234, and the arm portion 231R on the side of the other end (second end) thereof is coupled to a hydraulic pressure cylinder 5A as an actuating element configured to move the bearing unit 23 forwardly and backwardly in directions indicated by the arrowed line Q (with respect to the first corrugating roll 1). On the other hand, in the driving-side bearing unit 25, the arm portion 251L on the side of one end (first end) thereof is pivotally supported by the cartridge 26 through a shaft pin (concentric pin) 254, and the arm portion 251R on the side of the other end (second end) thereof is coupled to a hydraulic pressure cylinder 5B as an actuating element configured to move the bearing unit 25 forwardly and backwardly in directions indicated by the arrowed line Q (with respect to the first corrugating roll 1).

Each of the hydraulic pressure cylinders 5A, 5B (making up the actuating section 5) comprises a coupling pin (51A, 51B), a coupling block (52A, 52B), a cylinder rod (53A, 53B), and a cylinder casing (54A, 54B). The coupling block 52A (52B) is coupled to a coupling plate 233 (253) of the arm portion 231R (251R).

A pressure of the hydraulic pressure cylinder 5A (5B) is controlled to adjust a meshing pressure (nip pressure) between the fluted portions 111, 211 of the first corrugating roll 1 and the second corrugating roll 2 to fall within an adequate range. This is because, if the meshing pressure between the fluted portions 111, 211 is below the adequate range, the corrugating rolls fail to form flutes of a corrugated medium to have an adequate height, and, if the meshing pressure between the fluted portions 111, 211 is above the adequate range, the corrugating rolls are likely to cause breaking of a corrugated medium.

When the cartridge 6 is moved in the axial direction, the coupling between the coupling block 52A (52B) and the coupling plate 233 (253) is released. The cartridge 6 has a stopper pin 265 provided to protrude outwardly so as to support each of the uncoupled the arm portions 231R, 251R.

Two pressure gauges 55A, 55B (which are detecting elements making up a detecting section 55) are connected, respectively, to lower ends of the cylinder casings 54A, 54B. Each of the pressure gauges 55A, 55B is composed of a circular cylindrical-shaped load cell, and fastened to the bedplate 71 of the single facer body 7. A load detection direction of the pressure gauge 55A (55B) is coincident with a movement direction of the cylinder rod 53A (53B). An output terminal of each of the pressure gauges 55A, 55B is connected to the aftermentioned processing device 8.

As illustrated in FIGS. 2 and 4, the operating-side shaft pin 234 is provided with a manual-type eccentric pin adjusting mechanism 27 (first example). The manual-type eccentric pin adjusting mechanism 27 comprises a box-shaped adjustment arm 271 locked to the shaft pin 234, and a stopper pin 272 provided to stand on the cartridge 26. Two adjustment screws 273 are screwed, respectively, into two walls of the adjustment arm 271 opposed to each other across the stopper pin 272 to come in contact with respective opposite side surfaces of the stopper pin 272. An amount of eccentricity of the shaft pin 234 is adjusted by rotationally moving the adjustment screws 273 so as to rotationally move the adjustment arm 271 in directions indicated by the arrowed line P. In this manner, parallelism between the first corrugating roll 1 and the second corrugating roll 2 is adjusted.

As illustrated in FIGS. 5 and 6, the manual-type eccentric pin adjusting mechanism 27 (first example) may be replaced with an automatic-type eccentric pin adjusting mechanism 28 (second example). The automatic-type eccentric pin adjusting mechanism 28 comprises: a first spur gear 283 locked to the shaft pin 234; a drive motor 281 attached to the first end-side arm portion 231L through an attachment plate 284; and a second spur gear 282 locked to a rotary shaft of the drive motor 281. The first spur gear 283 is meshed with the second spur gear 282. An amount of eccentricity of the shaft pin 234 is adjusted by activating the drive motor 281 to rotationally move the second spur gear 282 and the first spur gear 283.

As illustrated in FIG. 4, in the second corrugating roll 2, two rolling bearings 235, 255 are fitted, respectively, on outer peripheral surfaces 221, 241 of the shaft portions 22, 24. The rolling bearings 235, 255 are locked, respectively, to the shaft portions 22, 24 through clips 223, 243, and fixed, respectively, to the bearing units 23, 25 through cover members 232, 252.

The roll body 21 and each of the shaft portions 22, 24 are internally formed, respectively, with hollow spaces 212, 222. Heating steam is supplied from a cap member 237 coupled to a distal end of the operating-side shaft portion 22 via a sealing member 236, and cooled steam (water) is discharged via a drain line 237h. During operation of the single facer, the roll body 21 is heated up to a given temperature by the heating steam. The cap member 237 is fixed to the bearing unit 23 by a screw member 238.

The first corrugating roll 1 is similarly configured to be supplied with heating stream to thereby heat the roll body 11 up to a given temperature during operation of the single facer.

### (Gluing Roll)

As illustrated in FIG. 1, the gluing roll 3 is a roll member which is disposed obliquely downward and leftward of the first corrugating roll 1, and configured to apply a glue solution stored in a glue dam 37, to flute tip regions of a corrugated medium formed by meshing between the fluted portions 111, 211 of the first corrugating roll 1 and the second corrugating roll 2.

A doctor roll 38 is in contact with an outer peripheral surface of the gluing roll 3 on a side opposite to the first corrugating roll 1. The doctor roll 38 is operable to adjust an amount of the glue solution to be applied from the gluing roll 3 to a corrugated medium.

The gluing roll 3 is pivotally rotatably supported by a gluing housing 32. A pressure cylinder 34 is coupled to the gluing housing 32 to server as an actuating section for moving the gluing roll 3 forwardly and backwardly with respect to the first corrugating roll 1. The pressure cylinder 34 has a cylinder rod 342 fastened to a sidewall of the gluing housing 32 through a coupling block 431. The pressure cylinder 34 has a cylinder casing 343 fastened to a pressure gauge (load cell) 35. The pressure gauge 35 is coupled to a sidewall 72 of the single facer body 7 through a coupling bracket 323. A load detection direction of the pressure gauge 35 is coincident with a movement direction of the cylinder rod 342. An output terminal of the pressure gauge 35 is connected to the aftermentioned processing device 8.

As illustrated in FIGS. 7 and 8, the gluing roll 3 has a roll body 31 composed of a cylindrical body, and two shaft portions 311 each protruding outwardly from a respective one of axially opposite ends of the roll body 31. Each of the shaft portions 311 is rotationally movably mounted to the gluing housing 32 through a bearing unit 33. A bearing element 14 is fittingly installed between the shaft portion 311 and the bearing unit 33, and a first sliding metal 321 is fittingly installed between the bearing unit 33 and the gluing housing 32. A drive pulley 312 is fastened to a distal end of the shaft portion 311. A drive belt 313 is wound around an outer peripheral surface of the drive pulley 312 to transmit a driving force to the drive pulley 312.

The bearing unit 33 comprises an eccentric cam 331, and a third spur gear 332 fastened to the eccentric cam 331 in the axial direction and coaxially rotatable together with the eccentric cam 331. The eccentric cam 331 is located outward of a wall of the gluing housing 32, and the third spur gear 332 is located inward of the wall of the gluing housing 32. An outer periphery of the eccentric cam 331 is formed in an annular shape eccentric to an axis of the shaft portions 311. An amount of eccentricity of the eccentric cam 331 is in the range of about 1 to 2 mm.

In order to automatically adjust the amount of eccentricity of the eccentric cam 331 synchronously in the axially opposite ends of the gluing roll 3, a synchronization shaft 335 is provided in parallel relation to the roll body 31. A second sliding metal 322 is fittingly installed between the synchronization shaft 335 and the gluing housing 335. A fourth spur gear 333 is fitted on each of axially opposite ends of the synchronization shaft 335. The fourth spur gear 333 is meshed with the third spur gear 332.

A fifth spur gear 334 is fastened to one end edge of the synchronization shaft 335, and meshed with a shaft gear 336 of a drive motor 337 fixed to one sidewall of the gluing housing 32.

The drive motor 337 is operable to rotationally move the eccentric cam 331 according to an amount of eccentricity of the eccentric cam 331 preliminarily set depending on a type of corrugated medium.

As illustrated in FIG. 1, when the cylinder rod 342 of the pressure cylinder 34 is moved in a direction causing a contraction thereof, the gluing housing 32 comes close to the first corrugating roll 1. In this process, as illustrated in FIGS. 7 and 9, outer peripheral surfaces of the eccentric cams 331 at the axially opposite ends come into contact, respectively, with stopper pins 36, 36B each protrudingly provided on a respective one of the driving and operating sides of the cartridge 26. The stopper pin 36 protrudingly provided on the driving side of the cartridge 26 is an eccentric pin, and the stopper pin 36B protrudingly provided on the operating side of the cartridge 26 is a concentric pin. The parallelism between the first corrugating roll 1 and the gluing roll 3 is adjusted by rotationally moving the eccentric pin.

As illustrated in FIG. 10, the stopper pin (eccentric pin) 36 has an eccentric portion 365 eccentrically formed at one end thereof and configured to come into contact with the eccentric cam 331. A worm wheel 361 is fastened to the other end of the stopper pin 36.

As illustrated in FIG. 11, the worm wheel 361 is meshed with an endless screw 362 positioned in a direction perpendicular thereto by a screw mount 364, to rotationally move an end 363 of the screw 362 in directions indicated by the arrowed line N to thereby adjust an amount of eccentricity of the stopper pin 6.

### (Pressure Roll)

As illustrated in FIG. 1, the pressure roll 4 is a roll member which is disposed obliquely upward and rightward of the first corrugating roll 1, and configured to glue a linerboard to flute tip regions of a corrugated medium applied with a glue solution from the gluing roll 3. In this embodiment, a roll member is used, and alternatively a belt member may also be used.

The pressure roll 4 is pivotally rotatably supported by the sidewalls 72 of the single facer body 7 upstandingly provided on the operating and driving sides thereof. The pressure roll 4 has two shaft portions 42 at respective axially opposite ends thereof, wherein each of the shaft portions 42 is pivotally rotatably supported by a bearing unit 43 (45). The bearing unit 43 (45) has a first arm portion 431L protruding upwardly (toward one end (first end) thereof), and a second arm portion 431R protruding laterally (toward the other end (second end) thereof. The first arm portion 431L is pivotally supported by the side wall 72 through a shaft pin 343 (454). The operating-side shaft pin 343 is eccentric pin, and the driving-side shaft pin 454 is a concentric pin.

The operating-side shaft pin 343 is provided with an eccentric pin adjusting mechanism 47. The eccentric pin adjusting mechanism 47 comprises a two-forked adjustment arm 471 locked to the shaft pin 343, and a stopper pin 472 provided to stand on the sidewall 72. Two adjustment screws 473 are screwed, respectively, into two forked portions of the adjustment arm 471 to come in contact with respective opposite side surfaces of the stopper pin 472. An amount of eccentricity of the shaft pin 343 is adjusted by rotationally moving the adjustment screws 473.

The second arm portion 431R of the bearing unit 43 is coupled to a pressure cylinder 6 as an actuating element configured to move the pressure roll 4 forwardly and backwardly with respect to the first corrugating roll 1. The pressure cylinder 6 comprises a coupling pin 61, a coupling block 62, a cylinder rod 63, and a cylinder casing 64. A pressure of the pressure cylinder 6 is controlled to adjust a nip pressure between the first corrugating roll 1 and the pressure roll 4 to fall within an adequate range.

A pressure gauge (load cell) 65 as a detecting element is connected to a lower end of the cylinder casing 64 of the bearing unit 43 (45). The pressure gauge 65 is fastened to the side wall 72 of the single facer body 7 through the attachment bracket 722. A load detection direction of the pressure gauge 65 is coincident with a movement direction of the cylinder rod 63. An output terminal of the pressure gauge 65 is connected to the aftermentioned processing device 8.

### (Single Facer Body)

As illustrated in FIG. 1, the single facer body 7 is formed in an approximately rectangular box shape in front view, and configured to allow the first corrugating roll 1 and the second corrugating roll 2 arranged in opposed relation to each other to be introduced therein and extracted therefrom in the axial direction through a window hole 721 formed in the sidewall 72 of the single facer body 7. Further, the cartridge 26 extracted in the axial direction can be replaced with another cartridge 26, together with the first corrugating roll 1 and the second corrugating roll 2. The cartridge 26 is fixed to the bedplate 71 by two cylinder members 731, 734 provided on the sidewall 72. In a state in which the cartridge 26 is fixed to the bedplate 71, right and left shoulders 264, 263 (see FIGS. 2 and 3) of the cartridge 26 are pressed by two positioning mechanisms 732, 735.

The single facer body 7 has an input slot for a corrugating medium NR, on a lower right side thereof. A guide roll 76 and a preheater roller 75 are arranged in adjacent relation to the corrugating medium input slot. The preheater roll 75 is configured to be subjected to steam heating based on the same structure as that of the second corrugating roll 2. The corrugating medium NR is pre-heated by the preheater roll 75, and then inserted between the first corrugating roll 1 and the second corrugating roll 2.

The single facer body 7 also has an input slot for a linerboard UR, on an upper left side thereof. A guide roll 78 and a preheater roller 77 are arranged in adjacent relation to the linerboard input slot. The preheater roll 77 is configured to be subjected to steam heating based on the same structure as that of the second corrugating roll 2. The linerboard UR is pre-heated by the preheater roll 77, and then fed to the pressure roll 4.

A turn-up roll 74 is disposed on a right side of the first corrugating roll 1 at a position opposed to the pressure roll 4. A single-faced corrugated paperboard sheet DB prepared by nipping a corrugated medium and a linerboard between the pressure role 4 and the first corrugating roll 1 to glue the linerboard to flute tip regions is transferred above the single facer body 7 via the turn-up roll 74 in order to convey it to the next station.

### <Parallelism Inspection Apparatus and Inspection Method Therefor>

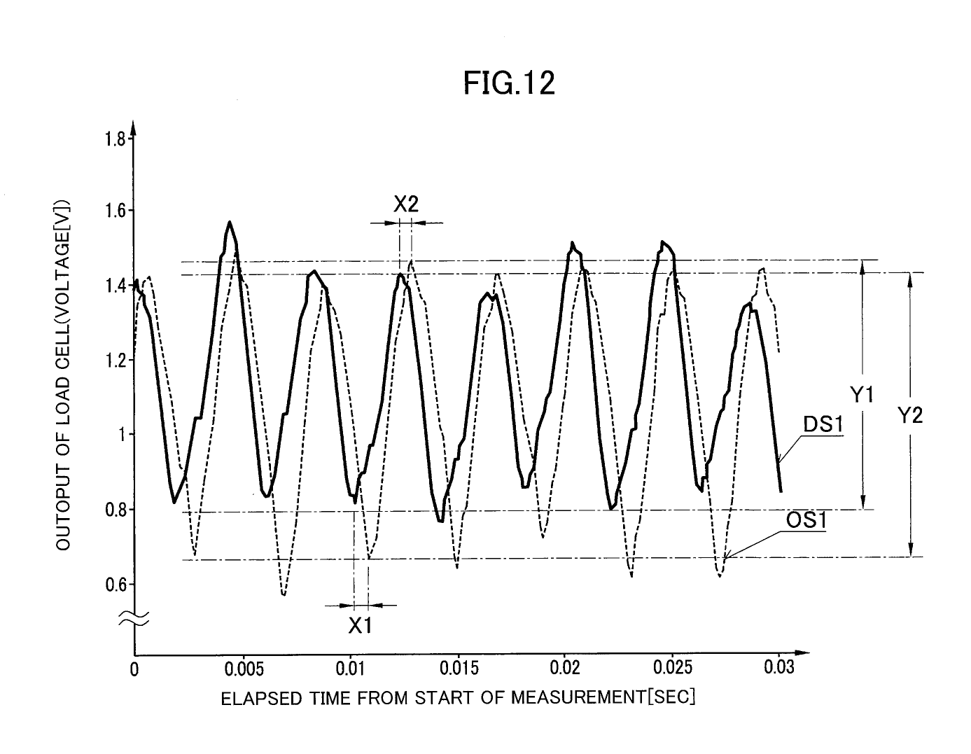

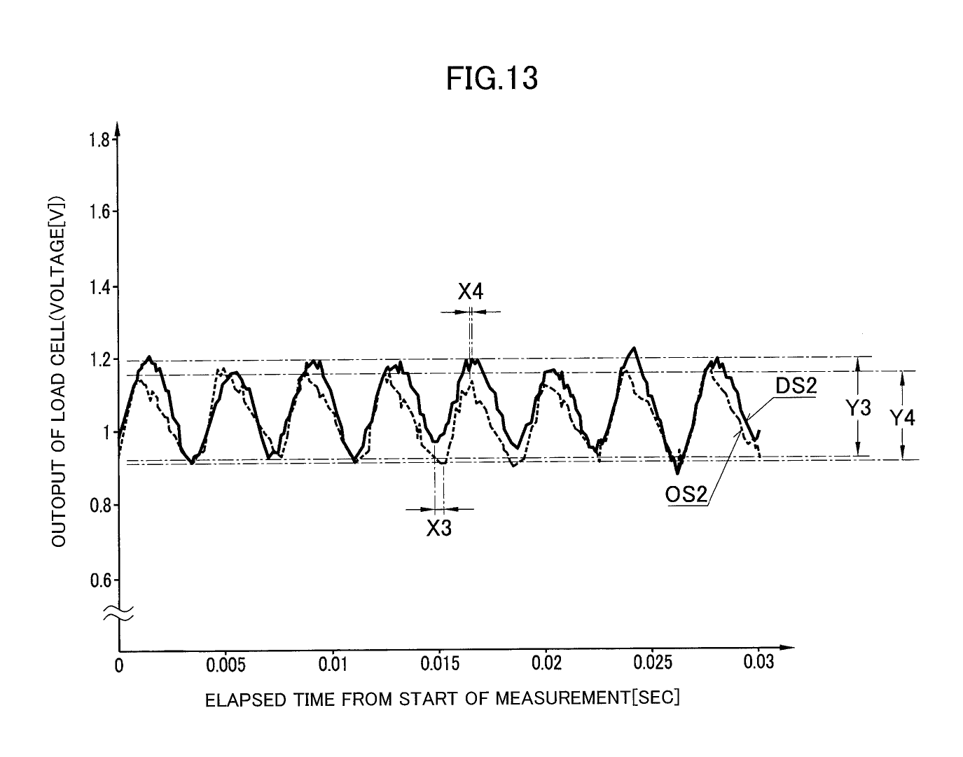

Next, with reference to FIGS. 12 and 13, a parallelism inspection apparatus for inspecting inter-roll parallelism, and an inspection method therefor, will be described. FIG. 12 is a graph presenting load curves (before parallelism adjustment) based on pressure gauges provided in respective pressure cylinders of the second corrugating roll illustrated in FIG. 1. FIG. 13 is a graph presenting load curves (after the parallelism adjustment) based on the pressure gauges provided in the respective pressure cylinders of the second corrugating roll illustrated in FIG. 1.

Although the single facer according to this embodiment is equipped with a corrugating roll parallelism inspection apparatus, a gluing roll parallelism inspection apparatus, and a pressure roll parallelism inspection apparatus, the three apparatuses have a common basic configuration. Thus, the corrugating roll parallelism inspection apparatus will be described in detail as a representative example.

### (Corrugating Roll Parallelism Inspection Apparatus and Inspection Method Therefor)

The corrugating roll parallelism inspection apparatus 10 in this embodiment comprises: the pressure gauges 55A, 55B (detecting section 55) provided, respectively, in the pressure cylinders 5A, 5B (actuating section 5) each coupled to the second end of the bearing unit (23, 25) in the second corrugating roll 2; a processing device 8 for processing electric output signals (voltages) from the pressure gauges 55A, 55B (detecting section 55); and a display device 9 having a monitor screen for displaying load output data processed by the processing device 8.

The operating-side pressure gauge 55A and the driving-side pressure gauge 55B are electrically connected to the display device 9 (see FIG. 1) via the processing device 8. Electric output signals (voltages) from the pressure gauges 55A, 55B are amplified and modulated by the processing device 8, and displayed on the monitor screen of the display device 9 in the form of separate load curves.

In the load curves displayed on the monitor screen of the display device 9, the horizontal axis represents an elapsed time (second) from state of measurement, and the vertical axis represents an output voltage (V) from each of the pressure gauges 55A, 55B.

FIG. 12 presents an operating-side load curve OS1 (broken line) and a driving-side load curve DS1 (solid line) each measured before adjusting parallelism between the corrugating rolls. FIG. 13 presents an operating-side load curve OS2 (broken line) and a driving-side load curve DS2 (solid line) each measured after adjusting the parallelism between the corrugating rolls.

As presented in FIG. 12, the operating-side load curve OS1 and the driving-side load curve DS1 are repetitive waveforms which repetitively rise and fall at approximately the same amplitudes Y1, Y2 with approximately the same cycles, wherein the two load curves OS1, DS1 deviate from each other in terms of cycle by about a time X1 or a time X2.

On the other hand, as presented in FIG. 13, the operating-side load curve OS2 and the driving-side load curve DS2 are repetitive waveforms which repetitively rise and fall at approximately the same amplitudes Y3, Y4 with approximately the same cycles, wherein the two load curves OS2, DS2 deviate from each other in terms of cycle by about a time X3 or a time X4.

Comparing the cycle offset amounts X1, X2 in the load curves OS1, DS1 presented in FIG. 12 to the cycle offset amounts X3, X4 in the load curves OS2, DS2 presented in FIG. 13, it is proven that the cycle offset amounts X1, X2 before adjusting the inter-roll parallelism are obviously greater than the cycle offset amounts X3, X4 after adjusting the inter-roll parallelism.

It is considered that a relatively large cycle offset (X1, X2) occurs between the driving-side load curve DS1 and the operating-side load curve OS1, because there is a deviation in the parallelism between the first corrugating roll 1 and the second corrugating roll 2, and a timing of meshing between the fluted portion 111 of the first corrugating roll 1 and the fluted portion 211 of the second corrugating roll 2 on the driving side and a timing of meshing between the fluted portion 111 of the first corrugating roll 1 and the fluted portion 211 of the second corrugating roll 2 on the operating side are inconsistent with each other by the cycle offset amount.

Thus, in the inspection method according to this embodiment, adequacy of the inter-roll parallelism is determined depending on whether or not a cycle offset amount in load curves detected by the pressure gauges 55A, 55B falls within a given criterion value. This makes it possible to quantitatively determine whether the inter-roll parallelism is in a normal state or in an abnormal state, accurately and easily within a short period of time.

Specifically, when a calculation result of the cycle offset amount in the load curves OS1, DS1 detected by the pressure gauges 55A, 55B provided, respectively, in the pressure cylinders 5A, 5B is greater than a given criterion value, it can be quickly determined that the inter-roll parallelism is in the abnormal state, and, on the other hand, when the calculation result is equal to or less than the given criterion value, it can be quickly determined that the inter-roll parallelism is in the normal state.

Thus, the method according to this embodiment makes it possible to perform inspection of the inter-roll parallelism easily without a short period of time without requiring proficiency. In addition, although a conventional method such as the pressure-sensitive sheet-based inspection method requires that the operation of the single facer is stopped and an operator enters the single facer, the method according to this embodiment can eliminate such requirements. The method according to this embodiment can also be used in inspection in which the inter-roll parallelism during an actual operation of single facer is continuously monitored.

Comparing the amplitude values Y1, Y2 in the load curves OS1, DS1 presented in FIG. 12 to the amplitude values Y3, Y4 in the load curves OS2, DS2 presented in FIG. 13, it is proven that the amplitude values Y3, Y4 after adjusting the inter-roll parallelism are less than the amplitude values Y1, Y2 before adjusting the inter-roll parallelism.

It is considered that the amplitude values Y3, Y4 after adjusting the inter-roll parallelism are less than the amplitude values Y1, Y2 before adjusting the inter-roll parallelism, because a timing of meshing between the fluted portion 111 of the first corrugating roll 1 and the fluted portion 211 of the second corrugating roll 2 are approximately coincident with each other both on the driving side and the operating side, and therefore a shock load occurring during the meshing is distributed over the entire fluted portions and reduced.

In this case, the adequacy of the inter-roll parallelism can be determined accurately and easily within a short period of time by comparatively evaluating a level of amplitudes in the operating-side and operating-side load curves displayed on the monitor screen of the display device 9.

In this embodiment, the cartridge 26 in which the first corrugating roll 1 and the second corrugating roll 2 are arranged in opposed relation is movably provided in the single facer body 7. Thus, it becomes possible to inspect and adjust the inter-roll parallelism through the cartridge 26. The intermediation of the cartridge 26 makes it possible to reduce noise from other rills mounted to the single facer body 7 (the gluing roll 3, the pressure roll 4, the preheater rolls 75, 77, etc.).

Further, the bearing unit 23 (25) has one end (first end) 231L (251L) pivotally supported by the cartridge 6 through the shaft pin 234 (254), and the other end (second end) 231R (251R) coupled to the pressure cylinder 5A (5B). Thus, when the fluted portion 111 of the first corrugating roll 1 and the fluted portion 211 of the second corrugating roll 2 are meshed with each other, the second end of the bearing unit 23 (25) is swingingly moved about the shaft pin 234 (254) at the first end serving as a support point. Therefore, a movement of the bearing unit 23 (25) can be transmitted to the pressure cylinder 5A (5B) coupled to the second end, while being amplified by the swinging movement of the second end.

Therefore, the pressure gauges 55A, 55B as a detecting section provided, respectively, in the pressure cylinders 5A, 5B as an actuating section can detect loads based on a temporal delay (lag) in terms of a meshing timing between the fluted portion 111 of the first corrugating roll 1 and the fluted portion 211 of the second corrugating roll 2, in an amplified manner while reducing noise. This makes it possible to inspect the adequacy of the inter-roll parallelism based on a difference between the loads, more accurately and easily with a shorter period of time.

Based on the above parallelism inspection result, the parallelism between the corrugating rolls can be automatically adjusted. In this case, in the aforementioned automatic-type eccentric pin adjusting mechanism 28 (second example), a motor control signal based on a cycle offset amount as the above parallelism inspection result is output from the processing device 8 to control rotation of the drive motor 281 to thereby rotationally move the shaft pin (eccentric pin) 234 by a given angle. In this way, a distance between axes of the first corrugating roll 1 and the second corrugating roll 2 on the operating side is automatically changed. On the other hand, a distance between axes of the first corrugating roll 1 and the second corrugating roll 2 on the driving side is not changed.

Therefore, even in the situation where the inter-roll parallelism is changed during operation of the single facer, under an influence of a difference in thermal expansion coefficient between the corrugating rolls and other rolls, and a frame of the single facer, the inter-roll parallelism can be automatically adjusted according to the change in such a manner that it falls within a given criterion value.

Thus, in this embodiment, not only during installation of the single facer or corrugating roll replacement but also during actual operation of the single facer, a deviation in the parallelism of the corrugating roll, etc., can be automatically adjusted while accurately inspecting the parallelism. This makes it possible to realize production of high-accuracy single-faced corrugated paperboard sheets while enhancing capacity utilization.

### (Other Roll Parallelism Inspection Apparatus and Inspection Method Therefor)

In this embodiment, each of the gluing roll 3 and the pressure roll 4 is also equipped with the inter-roll parallelism inspection apparatus.

A parallelism inspection apparatus 10B for the gluing roll 3 comprises: the pressure gauge (load cell) 35 fastened to the cylinder casing 343 of the pressure cylinder 34 coupled to the gluing housing 32; the processing device 8 for processing electric output signals (voltages) from the pressure gauge 35; and the display device 9 having the monitor screen for displaying load output data processed by the processing device 8.

A parallelism inspection apparatus 10C for the pressure roll 4 comprises: the pressure gauge (load cell) 65 fastened to the cylinder casing 64 of the pressure cylinder 6 coupled to the second end (431R) of each of the bearing units 43, 45; the processing device 8 for processing electric output signals (voltages) from the pressure gauges 65; and the display device 9 having the monitor screen for displaying load output data processed by the processing device 8.

Each of the parallelism inspection apparatus 10B for the gluing roll 3 and the parallelism inspection apparatus 10C for the pressure roll 4 has a common basic configuration to the parallelism inspection apparatus 10 of the corrugating roll. Thus, the pressure gauge as the detecting section provided in the pressure cylinder can detect loads based on a temporal delay (lag) in terms of a contact timing between the fluted portion 111 of the first corrugating roll 1 and the outer periphery of the gluing roll 3 or the pressure roll 4, while reducing noise. This makes it possible to inspect the adequacy of the inter-roll parallelism based on a difference between the loads, more accurately and easily with a shorter period of time.

### INDUSTRIAL APPLICABILITY

The present invention can be utilized, particularly, as a single facer equipped with a parallelism inspection apparatus for inspecting parallelism between at least one of a combination of two corrugating rolls and a combination of a corrugating roll and a gluing roll, and an inspection method for such a single facer.

What is claimed is:

1. A single facer for producing a single-faced corrugated paperboard in which a linerboard is glued to flute tip regions of a corrugated medium formed with corrugated flutes, comprising:
a first corrugating roll pivotally rotatably supported at axially opposite ends thereof;
a second corrugating roll pivotally rotatably supported at axially opposite ends thereof through respective bearing units, and disposed in opposed relation to the first corrugating roll;
a gluing roll disposed in opposed relation to the first corrugating roll;
a parallelism inspection apparatus for inspecting parallelism between the first corrugating roll and the second corrugating roll, the parallelism inspection apparatus comprising: an actuating section configured to move the bearing units of the second corrugating roll forwardly and backwardly with respect to the first corrugating roll; and a detecting section provided in the actuating section to detect values of a physical quantity transmitted, respectively, from the bearing units, wherein the parallelism inspection, based on the detected values of the physical quantity, detects the parallelism between the first corrugating roll and the second corrugating roll.

2. The single facer according to claim 1, wherein the actuating section and the detecting section of the parallelism inspection apparatus are, respectively, a pressure cylinder and a pressure gauge.

3. The single facer according to claim 1, wherein the single facer further comprises a cartridge in which the first corrugating roll and the second corrugating roll are arranged in opposed relation to each other, wherein each of the bearing units of the second corrugating roll has one end pivotally supported by the cartridge through a shaft pin, and the other end coupled to the actuating section, and wherein at least one of the shaft pins is an eccentric pin.

4. The single facer according to claim 1, wherein the single facer further comprises a display device configured to display the values of the physical quantity detected by the detecting section, in associated relation with a temporal axis.

5. The single facer according to claim 1, wherein the single facer further comprises an automatic adjusting device configured to, based on the values of the physical quantity detected by the detecting section, to automatically adjust a deviation in the parallelism between the first corrugating roll and the second corrugating roll.

6. The single facer according to claim 1, wherein the gluing roll is pivotally rotatably supported at axially opposite ends thereof through respective bearing units, and wherein the single facer further comprises a second parallelism inspection apparatus for inspecting parallelism between the first corrugating roll and the gluing roll, the second parallelism inspection apparatus comprising: a second actuating section configured to move the bearing units of the gluing roll forwardly and backwardly with respect to the first corrugating roll; and a second detecting section provided in the second actuating section to detect values of a physical quantity transmitted, respectively, from the bearing units of the gluing roll, wherein the second parallelism inspection apparatus, based on the detected values of the physical quantity, detects the parallelism between the first corrugating roll and the gluing roll.

7. The single facer according to claim 6, wherein the single facer further comprises: a gluing housing to which the gluing roll is mounted and the bearing units of the gluing roll are attached, wherein the second actuating section is coupled to the gluing housing; an eccentric cam provided in each of the bearing units of the gluing roll in eccentric relation to an axis of the gluing roll; and a stopper pin fixedly disposed in contact with an outer peripheral surface of the eccentric cam, wherein at least one of the stopper pins is an eccentric pin.

8. A method of inspecting the single facer according to claim 1, comprising the steps of calculating a cycle offset amount in values of the physical quantity detected by the detecting section, and determining adequacy of the parallelism between the first corrugating roll and the second corrugating roll, depending on whether or not the cycle offset amount falls within a given criterion value.
